(19) United States
(12) Patent Application Publication
(10) Pub. No.: US 2006/0098931 A1
(43) Pub. Date: May 11, 2006

(54) Fiber optic cable coupling enclosure and method and use

(76) Inventors: Keith E. Sibley, Willow Grove, PA (US); Steven F. Frederick, Jamison, PA (US); Charles R. Herrmann, Rydal, PA (US); Charles F. Niesley, Lansdale, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/211,228

(22) Filed: Aug. 24, 2005

Related U.S. Application Data
(62) Division of application No. 10/698,306, filed on Oct. 31, 2003.

(51) Int. Cl. G02B 6/00

(52) U.S. Cl. 385/135

(57) ABSTRACT

A fiber optic cable routing apparatus includes a body having an inlet and an outlet, and a removable fiber tray configured to be housed within the body, wherein the removable fiber tray is configured to accommodate fiber optic cable.

This is a divisional application of U.S. application Ser. No. 10/698,306 filed on Oct. 31, 2003.

### FIELD OF THE INVENTION

The present system and method relate to fiber optic cables. More particularly, the present system and method provide a home mountable fiber optic cable enclosure facilitating the coupling of fiber optic cables.

### BACKGROUND OF THE INVENTION

Fiber optics (optical fibers) are long, thin strands of very pure glass, approximately the diameter of a human hair. These optical fibers are arranged in bundles called optical cables and used to transmit light signals over long distances. A single optical fiber typically includes a core—a thin glass center of the fiber where light travels, a cladding—outer optical material surrounding the core that reflects the light back into the core, and a buffer coating—a plastic coating that protects the fiber from both damage and moisture.

The light in a fiber-optic cable travels through the core by constantly bouncing from the cladding, a principle called total internal reflection. The cladding does not absorb any light from the core thereby allowing the light wave to travel great distances. Compared to conventional copper wire, optical fibers are thinner, have a higher carrying capacity, experience less signal degradation, do not experience signal interference between fibers, have low power requirements, are ideally suited for carrying digital information, are non-flammable, are lightweight, and are flexible.

### SUMMARY OF THE INVENTION

A fiber optic cable routing apparatus includes a body having an inlet and an outlet, and a removable fiber tray configured to be housed within the body, wherein the removable fiber tray is configured to accommodate fiber optic cable.

### BRIEF DESCRIPTION OF THE DRAWINGS

The accompanying drawings illustrate various embodiments of the present method and system and are a part of the specification. Together with the following description, the drawings demonstrate and explain the principles of the present method and system. The illustrated embodiments are examples of the present method and system and do not limit the scope thereof.

FIG. 1 is a system illustration showing a fiber optic communication system according to one exemplary embodiment.

FIG. 2 is a perspective view of an optical network terminal coupled to a fiber management enclosure according to one exemplary embodiment.

FIG. 3 is an exploded view of an enclosure bracket according to one exemplary embodiment.

FIG. 4 is an exploded view illustrating a fiber tray housing according to one exemplary embodiment.

FIG. 5 is an exploded view illustrating a fiber tray according to one exemplary embodiment.

FIG. 6 is an exploded view illustrating an enclosure cover according to one exemplary embodiment.

FIG. 7 is a flow chart illustrating a method for using an exemplary embodiment of a fiber management enclosure according to one exemplary embodiment.

FIG. 8 is a cross-sectional view illustrating the insertion of a fiber-optic cable into a fiber tray according to one exemplary embodiment.

FIG. 9 is a cross-sectional view illustrating the insertion of a fiber-optic cable into a fiber tray according to one exemplary embodiment.

FIG. 10 is a cross-sectional view illustrating the insertion of a second fiber-optic cable into a fiber tray according to one exemplary embodiment.

FIG. 11 is a schematic view illustrating a fiber-optic cable being coupled to an optical network terminal according to one exemplary embodiment.

### DESCRIPTION OF PREFERRED EMBODIMENTS

The present specification describes exemplary systems and a methods for coupling a fiber optic cable to a home or small business. More specifically, the present system and method provides an easily accessible and environmentally protected enclosure that facilitates the installation of fiber optic cable at a consumer's home or office. The present system and method facilitate the installation of fiber optic cable at a consumer's home or office by simplifying the installation of service cable, channeling the internally routed fiber, protecting the fiber in an environmentally hardened enclosure, and offering installation versatility in allowing the fiber to be installed prior to the installation of an optical network terminal.

In the present specification and in the appended claims, the term “optical network terminal” or “ONT” is meant to be understood broadly as any optical networking device that terminates an optical network at a desired location and provides an interface with existing wiring at that desired location. Moreover, an “optical network terminal” or “ONT” may, but is not necessarily required to, deliver triple play residential voice, video, and data services. The terms “fiber optic cable, ““fiber optics,” and “fiber strands” are meant to be understood as any one or more long thin strands of glass configured to transmit light signals in an optical networking environment. The term “consumer location” is meant to be understood broadly as any home, business, or remote location where a consumer may desire a connection to an optical network terminal.

In the following description, for purposes of explanation, numerous specific details are set forth in order to provide a thorough understanding of the present system and method for providing a fiber optic management enclosure. It will be apparent, however, to one skilled in the art that the present method may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

Exemplary Overall Structure

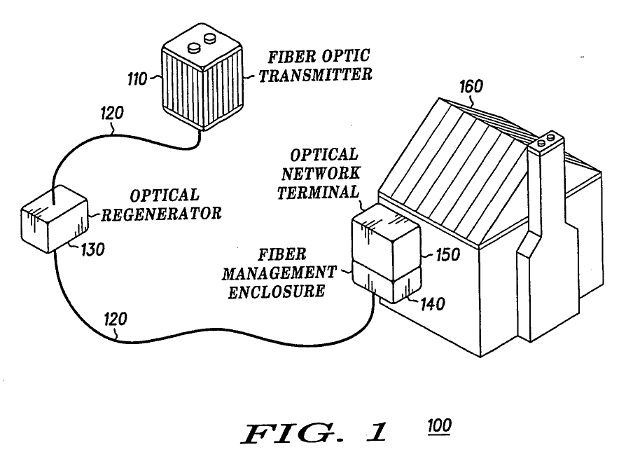

FIG. 1 is a system illustration showing a fiber optic communication system according to one exemplary embodiment. As shown in FIG. 1, a fiber optic communication system (100) may include a fiber optic transmitter (110) communicatively coupled to a fiber optic cable (120). The fiber optic cable (120) is subsequently communicatively coupled to a fiber management enclosure (140) according to one exemplary embodiment. As shown in FIG. 1, a fiber optic communication system (100) may also optionally include an optical regenerator (130) coupled to the fiber optic cable (120). The fiber management enclosure (140) that is communicatively coupled to the fiber optic cable (120) may also be communicatively coupled to an optical network terminal (150). The optical network terminal (150) then communicatively couples the present fiber optic communication system (100) to a designated consumer location (160). The above-mentioned components of the fiber optic communication system (100) will now be described in further detail below.

The fiber optic transmitter (110) illustrated in FIG. 1 originates the optical signal that is to be routed to the consumer location (160). The fiber optic transmitter (110) may be any transmitter configured to receive external commands and/or subsequently direct an optical device to turn the optical light “on” and “off” in the correct sequence, thereby generating a light signal. The transmitter may be physically close to or far from the fiber optic cable (120) as long as it is optically coupled to the fiber optic cable (120). Additionally, the fiber optic transmitter (110) may even include a lens (not shown) configured to focus the light into the fiber optic cable (120). The optical light transmitted by the fiber optic transmitter (110) may be any appropriate wavelength and may be transmitted by any photonic emitter or light emitting diode (LED).

The fiber optic transmitter (110) is optically coupled to the fiber optic cable (120) as illustrated in FIG. 1. The fiber optic cable (120) is the medium by which the optical signal that is transmitted from the fiber optic transmitter (110) reaches the consumer location (160). The fiber optic cable (120) may include any number of thin strands of substantially pure glass or other medium configured to carry digital information over long distances. Moreover, the fiber optic cable (120) illustrated in FIG. 1 may be only a single strand of substantially pure glass configured to carry digital information. The fiber optic cable (120) may include a core, a cladding, and a buffer coating.

The optional optical regenerator (130) illustrated in FIG. 1 may be used to regenerate an optical signal as it is transported through the fiber optic cable (120). Signal loss may occur in the fiber optic cable (120) when the optical light is transmitted through the fiber, especially when the fiber optic transmitter (110) is separated from the optical network terminal by long distances (more than a half mile, or about 1 km). Consequently, one or more optical regenerators (130) may be spliced along the fiber optic cable (120) to boost the degraded optical light signals. The optical regenerator (130) illustrated in FIG. 1 may be any regenerator configured to regenerate an optical signal and may include doped optical fibers. The doped portion of the optical fibers may be infiltrated by a photon emitter. When the degraded signal comes into the doped coating, a new, stronger light signal with the same characteristics as the incoming weak light signal is emitted.

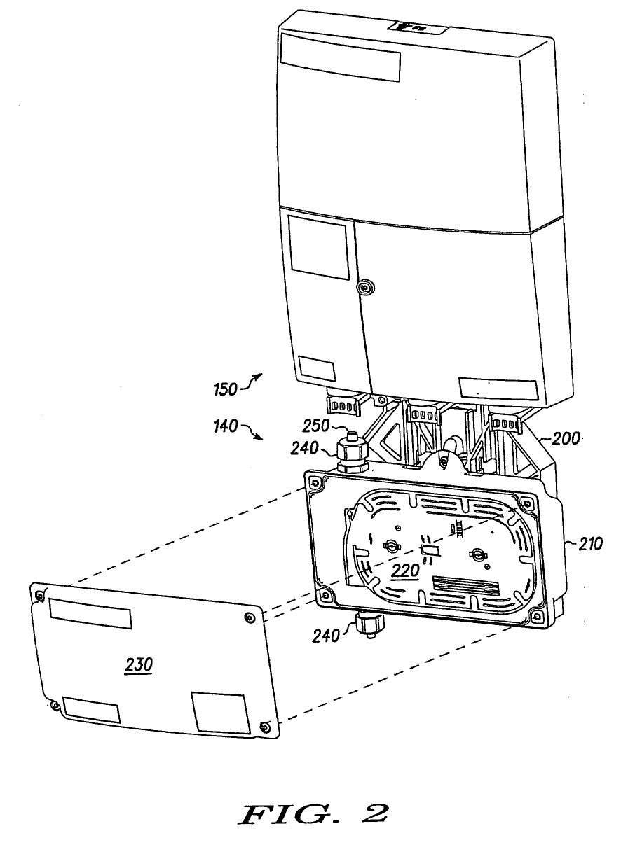

At the consumer end of the exemplary fiber optic communication system (100), illustrated in FIG. 1, a fiber management enclosure (140) is communicatively coupled to the optical network terminal (150). The fiber management enclosure (140) shown in FIG. 1 may be any environmentally protected enclosure implementing the teachings of the present system and method as will be explained in further detail below with reference to FIGS. 2 through 6.

The optical network terminal (150) communicatively coupled to the fiber management enclosure (140) may be any device configured to receive optical signals from the fiber optic cable (120) and provide an interface for the consumer location (160). The optical network terminal (150) may provide a central distribution point for all fiber optic services in the consumer location (160) including, but in no way limited to, telephone service interfaces for voice services, an F-connector for broadcast and premium video services as well as broadband data services, set top box return channel processing, etc.

The exemplary optical network terminal (150) illustrated in FIG. 1 is subsequently coupled to the consumer location (160). The consumer location (160) in FIG. 1 is illustrated as a consumer's home. However, the present system and method may be incorporated to provide optical signals to any desired consumer location including, but in no way limited to, a small business, a home, an isolated terminal, etc. Further details of an exemplary fiber management enclosure (140) will now be explained below.

FIG. 2 is a perspective view of an optical network terminal (150) coupled to a fiber management enclosure (140) according to one exemplary embodiment. As shown in FIG. 2, the fiber management enclosure (140) includes an enclosure bracket (200), a fiber tray housing (210), a fiber tray (220), an enclosure cover (230), and a number of compression fittings (240) including a storage plug (250).

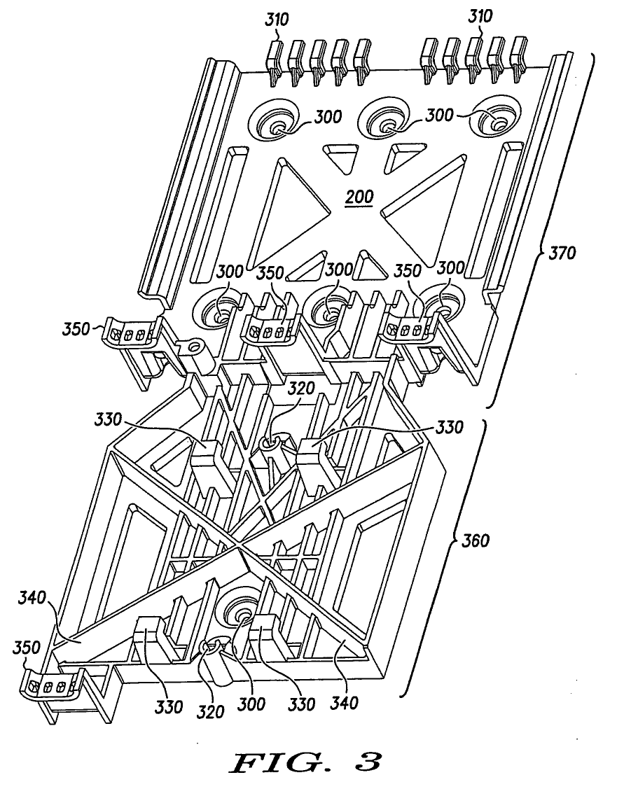

As shown in FIG. 2, the enclosure bracket (200) forming part of the fiber management enclosure (140) may be physically coupled to both the optical network terminal (150) and the fiber tray housing (210). The enclosure bracket (200) is configured to coupled both the fiber management enclosure (140) and the optical network terminal (150) to the consumer location ( 160; FIG. 1). Further details of one exemplary embodiment of the enclosure bracket (200) are illustrated in FIG. 3.

As shown in FIG. 3, the enclosure bracket (200) includes a body (305) having a substantially flat posterior surface (not shown) configured to be coupled to the consumer location (160; FIG. 1). A number of bracket mounting orifices (300) are disposed in the body (305) of the enclosure bracket (200). The bracket mounting orifices (300) are configured to facilitate the coupling of the enclosure bracket (200) to the consumer location (160; FIG. 1) by receiving a bracket mounting fastener (not shown) in the form of a screw, a brad, a bolt, or any other appropriate fastener. While seven circular bracket mounting orifices (300) are illustrated in FIG. 3, any appropriate number or shape of bracket mounting orifices (300) may be implemented according to the present system and method.

FIG. 3 also illustrates that the enclosure bracket (200) may be divided into two sections, an optical network portion (370) and an enclosure portion (360) according to one exemplary embodiment. As shown, the optical network portion (370) of the enclosure bracket (200) includes a number of optical network terminal (ONT) mounting extrusions (310) and a number of cable reception guides (350). The optical network portion (360) of the enclosure bracket (310) is configured to receive and couple an optical network terminal (150; FIG. 2) as shown in FIG. 2. The ONT mounting extrusions (310) are shown in FIG. 3 as a number of vertically curving extrusions (310) configured to be received by a corresponding orifice (not shown) in the ONT (150; FIG. 2). However, the ONT mounting extrusions (310) may take any shape or form configured to securely couple the ONT (150; FIG. 2) to the enclosure bracket (200) including, but in no way limited to, an extrusion receiving socket, a fastener receiving orifice, etc. The optical network portion (370) of the enclosure bracket (200) also includes a number of cable reception guides (350) configured to facilitate the reception of fiber optic cable (120; FIG. 1) by the ONT (150; FIG. 2) without damaging the fiber optic cable. As shown in FIG. 3, the cable reception guide (350) may include a semi-circular extrusion corresponding to an input orifice of the ONT (150; FIG. 2). Alternatively, the cable reception guide (350) may take any form configured to guide the fiber optic cable (120; FIG. 1) between components.

The enclosure portion (360) of the enclosure bracket (200) shown in FIG. 3 includes a number of components configured to facilitate the coupling of the fiber tray housing (210; FIG. 2) to the enclosure bracket. As illustrated in FIG. 3, an exemplary embodiment of the enclosure portion may include a number of enclosure mounting hooks (330), a plurality of captive fastener securing orifices (320), a number of structural members (340), and a cable reception guide (350).

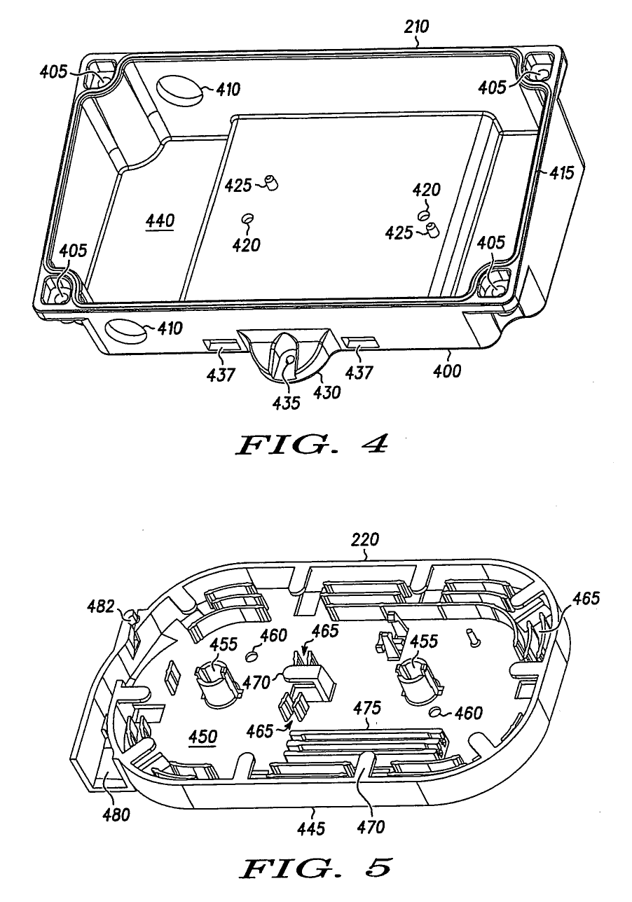

The mounting hooks (330) illustrated in FIG. 3 are configured to be coupled to a number of hook receiving orifices (437; FIG. 4) disposed in the fiber tray housing (210; FIG. 2). Coupling of the mounting hooks (330) to the hook receiving orifices (437; FIG. 4) provides for positionally fixing the fiber tray housing (210; FIG. 2) on the enclosure bracket (200). While four extruded enclosure mounting hooks (330) are illustrated in FIG. 3, any number or cross-sectional shape may be used to form the enclosure mounting hooks (330) including, but in no way limited to, an extrusion receiving socket, a fastener receiving orifice, etc.

The captive fastener securing orifices (320) illustrated in FIG. 3 are configured to further couple the fiber tray housing (210; FIG. 2) to the enclosure bracket (200) after the above-mentioned mounting hooks (300) have been coupled to the hook receiving orifices (437; FIG. 4) of the fiber tray housing (210; FIG. 2). The captive fastener securing orifices (320) are configured to receive a fastener. The fastener received by the captive fastener securing orifice (320) may be, but is in no way limited to, a screw, a brad, a pin, a nail, a hook, etc.

The structural members (340) illustrated in FIG. 3 are configured to add strength to the enclosure bracket (200) while adding minimal weight or material requirements. The structural members (340) may add strength to the enclosure bracket (200 ) to allow the enclosure bracket (200) to support the ONT (150; FIG. 2) and the fiber management enclosure (140; FIG. 2) without experiencing structural buckling or failure. As shown in FIG. 3, the structural members (340) may be extrusions disposed in any number of orientations including, but in no way limited to, diagonally across the body (305) of the enclosure bracket, vertically across the length of the enclosure bracket body (305), and/or horizontally across the width of the body (305).

Disposed on the end of the enclosure bracket (200) is a cable reception guide (350) according to one exemplary embodiment. As explained above, the cable reception guide (350) may include a semi-circular extrusion corresponding to an input orifice of the ONT (150; FIG. 2). Alternatively, the cable reception guide (350) may take any form configured to guide the fiber optic cable (120; FIG. 1) between components.

Returning again to FIG. 2, the fiber tray housing (210) is coupled to the enclosure bracket (200). Additionally, the fiber tray housing (210) is shown coupled to the fiber tray (220). FIG. 4 further illustrates the individual components of an exemplary embodiment of a fiber tray housing (210). As shown in FIG. 4, the fiber tray housing (210) includes a housing body (400) having a tray receiving seat (440) disposed therein. A number of cover receiving orifices (405) are disposed in the corners of the face of the fiber tray housing (210). A weather tight seal receiving channel (415) is also disposed on the face of the housing body (400). A number of tray receiving orifices (420) and guide pins (425) are disposed within the tray receiving seat (440) for positioning the fiber tray (220) within the tray receiving seat (440). One or more captive fastener extrusions (430) including a captive fastener orifice (435) are disposed on the outer surface of the housing body (400) to aid in coupling the fiber tray housing (210) to the enclosure bracket (200; FIG. 3). A plurality of hook receiving orifices (437) and fitting orifices (410) are also disposed on the outer surface of the housing body (400). The details of the fiber tray housing will now be explained in greater detail below.

The exemplary housing body (400) illustrated in FIG. 4 is a structural housing configured to be securely coupled to the enclosure bracket (200; FIG. 2) described above while receiving a fiber tray (220; FIG. 2). While the exemplary housing body (400) illustrated in FIG. 4 has a rectangular cross-section, the present housing body may assume any cross-sectional shape to accommodate the reception of a fiber tray (220; FIG. 2). The tray receiving seat (440) disposed in the exemplary housing body (400) may be a recessed portion of the housing body (400) shaped such that it may receive and facilitate the coupling of a fiber tray (220; FIG. 2).

A number of tray receiving orifices (420) and guide pins (425) are also disposed within the tray receiving seat (440) to aid in the positioning and proper coupling of the fiber tray (220; FIG. 2) within the tray receiving seat (440). As shown in FIG. 4, the guide pins (425) may be cylindrical extrusions that correspond with a matching number of guide pin orifices (460; FIG. 5) disposed in the fiber tray (220; FIG. 2). When the fiber tray (220; FIG. 2) is correctly positioned above the tray receiving seat (440), the guide pins (425) may be translated through the guide pin orifices (460; FIG. 5) thereby positioning and somewhat securing the fiber tray (220) in the tray receiving seat (440). Additionally, once the guide pins (425 ) are positioned in the guide pin orifices (460; FIG. 5), the tray receiving orifice (420) will be concentric with a tray securing orifice (455; FIG. 5) such that a fastener may be passed through the concentric orifices to further secure the fiber tray (220; FIG. 2) with in the tray receiving seat (440).

One or more cover receiving orifices (405) are also disposed on the edge of the face of the fiber tray housing (210). The cover receiving orifices (405) are configured to receive one or more fasteners to secure an enclosure cover (230; FIG. 3) to the fiber tray housing (210). The enclosure cover (230; FIG. 3) will increase the weather tight protection offered by the fiber management enclosure (140; FIG. 2). A weather tight seal receiving channel (415) is also disposed on the face of the housing body (400) to further enhance the weather tight protection offered by the fiber management enclosure (140; FIG. 2). The weather tight seal receiving channel (415) may be disposed internally to the cover receiving orifices (405) as shown in the exemplary embodiment of FIG. 4. The weather tight seal receiving channel (415) is configured to receive a seal disposed on the enclosure cover (230; FIG. 2) that may be a polymer bead or gasket which when compressed by the coupling of the enclosure cover (230; FIG. 2) onto the fiber tray housing (210) provides a weather tight seal around the tray receiving seat (440). A weather tight seal or an environmental seal is meant to be understood as a seal that prevents water or other environmental elements from contacting the surface of sealed components.

The captive fastener extrusions (430) that include a captive fastener orifice (435) are also disposed on the outer surface of the housing body (400) to aid in coupling the fiber tray housing (210) to the enclosure bracket (200; FIG. 3). The captive fastener extrusions (430) and their associated captive fastener orifices (435) are disposed on the outer surface of the fiber tray housing (210) such that when correctly positioned on the enclosure bracket as shown in FIG. 2, the captive fastener orifice (435) will be concentric with the captive fastener securing orifice (320) of the enclosure bracket. This concentricity will allow a fastener to be inserted into the concentric orifices thereby securely coupling the fiber tray housing (210) to the enclosure bracket (200; FIG. 3).

Correct positioning of the fiber tray housing (210) onto the enclosure bracket (200; FIG. 3) is further enhanced by the hook receiving orifices (437). A number of hook receiving orifices (437) disposed on the outer surface of the housing body (400) are configured to receive the enclosure mounting hooks (330; FIG. 3) of the enclosure bracket (200; FIG. 2) according to one exemplary embodiment. When the hook receiving orifices (437) correctly receive the enclosure mounting hooks (330), the fiber tray housing (210) is disposed on the enclosure bracket such that the above-mentioned coupling is facilitated. The above-mentioned system of fasteners and mounting hooks facilitates the fastening as well as rapid removal of the fiber tray housing (210) from the enclosure bracket (200; FIG. 2) depending on the needs of the installer.

Fitting orifices (410) are also disposed on the outer surface of the housing body (400). The fitting orifices (410) illustrated in FIG. 4 are configured to receive a number of compression fittings (240; FIG. 2) as shown in FIG. 2. Returning to FIG. 2, when the fiber management enclosure (140) is assembled, the fitting orifices (410; FIG. 4) are occupied by a number of compression fittings (240) and possibly a storage plug (250). The compression fittings (240) are water tight compression fittings that, when compressed, form a weather tight seal around any fiber optic cable (120; FIG. 1) passing through the compression fitting (240). If no fiber optic cable (120; FIG. 1) is passing through the compression fitting (240), a storage plug (250) may be placed within the compression fitting maintaining the weather tight seal of the fiber management enclosure by blocking the passage of anything through the storage plug (250).

Disposed within the fiber tray housing (210) is a fiber tray (220) as shown in FIG. 2. The fiber tray (220) is configured to safely and efficiently house a reserve of fiber optic cable (120; FIG. 1) and is further illustrated and described in FIG. 5. As shown in FIG. 5, an exemplary fiber tray (220) includes a tray body (445) having a fiber receiving recess (450) disposed therein. A number of fiber optic cable (120; FIG. 1) facilitating components are within the fiber receiving recess (450) including, but in no way limited to, a plurality of tray securing orifices (455), a plurality of guide pin orifices (460), fiber channels (465), fiber retaining extrusions (470), a fusion splice housing (475), and a fiber splice tray (480).

The cross-sectional area of the tray body (445) of the fiber tray (220) is configured to facilitate coupling with the fiber tray housing (210; FIG. 2). While the tray body (445) illustrated in FIG. 5 has a rectangular cross-section, any cross-section corresponding with the tray receiving seat (440; FIG. 4) may be incorporated. The fiber receiving recess (450) disposed in the tray body (445) is a recessed area of the surface of the tray body (445) that may assume any configuration.

Housed within the fiber receiving recess (450), is a plurality of tray securing orifices (455) and guide pin orifices (460). The tray securing orifices (455) correspond with the tray receiving orifice (420; FIG. 4) of the fiber tray housing (210; FIG. 4) and the guide pin orifice (460) positionally corresponds with the guide pins (425; FIG. 4) of the fiber tray housing (210; FIG. 4) such that when the fiber tray (220) is correctly positioned in the fiber tray housing (210; FIG. 4) corresponding components are concentric.

A number of fiber channels (465) topped by fiber retaining extrusions (470) are also disposed in the fiber receiving recess (450). The fiber channels (465) illustrated in FIG. 5 are a number of extrusions formed perpendicular to the fiber receiving recess (450) such that a series of channels or gaps are formed between the extruding fiber channels (465). The channels or gaps that are formed between the fiber channels (465) are configured to house fiber optic cables. While FIG. 5 illustrates a number of fiber channels (465) configured to house up to three fiber optic cables (120; FIG. 1), any number of channels or gaps may be formed within the fiber receiving recess (450) of the fiber tray (220). The channels or gaps formed within the fiber receiving recess (450) of the fiber tray (220) have gradual curves in order to prevent any damage to the internal fibers of a received fiber optic cable (120; FIG. 1). FIG. 5 also illustrates fiber retaining extrusions (470) extending over the fiber channels (465). The fiber retaining extrusions (470) aid in the retention of fiber optic cable (120; FIG. 1) that has been spooled in the fiber channels (465). While eleven fiber retaining extrusions are illustrated in FIG. 5, any number of fiber retaining extrusions (470) may be incorporated in the present fiber management enclosure (140).

A fusion splice housing (475) is also shown disposed in the fiber receiving recess (450) of the exemplary fiber tray (220) according to one exemplary embodiment. The fusion splice housing (475) illustrated in FIG. 5 is configured to securely house a fusion splice created by localized heating of the ends of two joined fibers. The fusion splice housing (475) is configured to securely house the fusion splice by providing structural supports on each side of the fusion splice inserted therein. This minimizes the motion allowed the fusion splice thereby reducing stresses.

A fiber splice tray (480) and a fiber channel or ferrule (482) are also disposed on the fiber tray (220). As shown in FIG. 5, the fiber splice tray (480) and the fiber channel or ferrule (482) are positioned such that they correspond with the fitting orifices (410; FIG. 4) of the fiber tray housing (210; FIG. 4). The fiber splice tray (480) is configured to receive incoming fiber optic cable (120; FIG. 1) through the compression fitting (240; FIG. 2) and to route the cable to the fiber channels (465). The fiber splice tray (480) also provides a somewhat flat surface where a fusion splice may be performed. The fiber channel or ferrule (482) is positioned such that any fiber optic cable (120; FIG. 1) or any subsequently coupled connector may be routed out of the fiber management enclosure through the corresponding compression fitting (240).

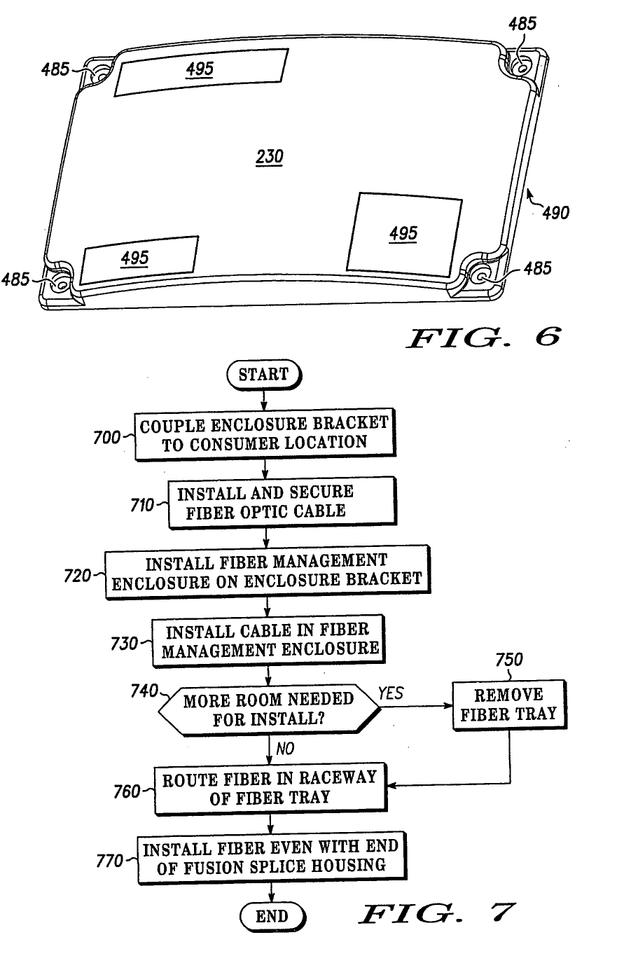

Returning again to FIG. 2, the fiber management enclosure (140) is environmentally sealed by the application of the enclosure cover (230). The components of the enclosure cover are illustrated in FIG. 6. As shown in FIG. 6, the fiber management enclosure (140) may include a number of cover securing orifices (485), a seal housing groove (490), and a number of locations for optional protective labeling (495). The cover securing orifices (485) illustrated in FIG. 6 correspond to the cover receiving orifices (405; FIG. 4) illustrated in FIG. 4, such that when the enclosure cover (230) is correctly coupled to the fiber tray housing (210; FIG. 4), the cover securing orifices (485) are concentric with the cover receiving orifices (405; FIG. 4) to allow for the insertion of a fastener. When coupled to the fiber tray housing (210; FIG. 4), the seal housing groove (490) couples and compresses a seal disposed therein (not shown) in the seal receiving channel (415; FIG. 4) to form an environmentally tight seal. The seal (not shown) disposed within the seal housing groove (490) may be any environmentally sealing material or structure including, but in no way limited to, an o-ring or a gasket. Additionally, the protective labeling (495) illustrated on the enclosure cover (230) may be any protective labeling used to display, among other things, safety warnings, product names, etc.

The components of the fiber management enclosure (140) illustrated in FIGS. 3 through 6 may be manufactured using any number of materials including, but in no way limited to, plastics, metals, or composites. Moreover, any number of manufacturing processes may be used to form the components of the fiber management enclosure (140) including, but in no way limited to, machining, injection molding, rolling, extruding, punching, stamping, deep drawing, blow molding, thermoforming, compression molding, transfer molding, and/or casting.

Exemplary Implementation and Operation

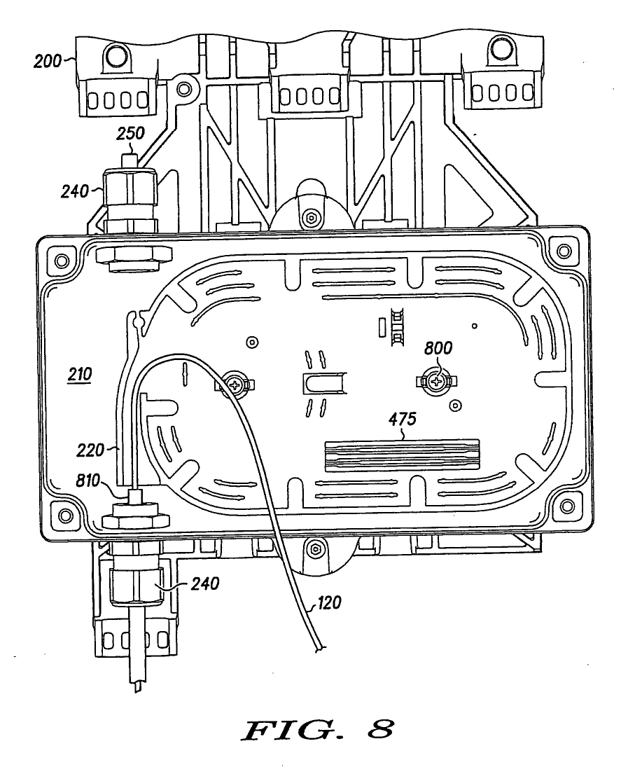

FIG. 7 illustrates a method for using the present fiber management enclosure (140; FIG. 2) according to one exemplary embodiment. As shown in FIG. 7, the present method is initiated when the enclosure bracket is coupled to the consumer location (step 700). Once the fiber management enclosure is attached, a fiber optic cable (120; FIG. 2) may be installed and secured to the consumer location (step 710). With the fiber optic cable installed, the fiber management enclosure (140; FIG. 2) may be installed on the enclosure bracket (step 720) and the fiber optic cable may be installed in the fiber management enclosure (step 730). During the installation of the fiber management enclosure (step 730), additional room may be needed for the installation of the fiber optic cable (step 740). If so (YES, step 740), the fiber tray (220; FIG. 2) may be removed from the fiber tray housing (step 750) to give the installer additional room. If, however, there is sufficient room to install the fiber optic cable in the fiber management enclosure without removing the fiber tray (NO, step 740), the fiber optic cable may be routed in the raceways of the splice tray (step 760). Once the fiber optic cable is appropriately routed in the raceways, the fiber optic cable may be installed in the fusion splice housing and the fiber management enclosure reassembled (step 770). The above-mentioned steps will now be described in further detail below.

As shown in FIG. 7, the exemplary method begins by coupling the enclosure bracket to the consumer location (step 700). Returning again to FIG. 3, the enclosure bracket (200) may be coupled to the consumer location using the bracket mounting orifices (300) formed in the body (305) of the enclosure bracket (200). A fastener such as, but in no way limited to, a screw or a nail may be passed through the bracket mounting orifice (300) and coupled to the consumer location.

Returning again to FIG. 7, once the enclosure bracket is coupled to the consumer location (step 700), the fiber optic cable (120; FIG. 1) may be installed and secured to the consumer location (step 710). The fiber optic cable (120; FIG. 1) may be routed from a source location to the consumer location where it is installed and coupled to the consumer location just below or alternatively just above the enclosure bracket (200; FIG. 2). The fiber management enclosure (140; FIG. 2) may also be installed on the enclosure bracket (step 720). As shown in FIG. 3, there may be a number of enclosure mounting hooks (330) and captive fastener securing orifices (320) designed to receive and secure the fiber management enclosure (140; FIG. 2) onto the enclosure bracket (200). In order to couple the fiber management enclosure (140; FIG. 2) onto the enclosure bracket (200), the enclosure mounting hooks (330) may be inserted into hook receiving orifices (437; FIG. 4) on the fiber tray housing (210; FIG. 2) of the fiber management enclosure (140; FIG. 2). Once secured by the enclosure mounting hooks (330), a fastener may then be inserted through the captive fastener orifice (435; FIG. 4) of the fiber tray housing (210; FIG. 2) and into the captive fastener securing orifice (320) to further couple the fiber management enclosure (140; FIG. 2) to the enclosure bracket (200).

With the fiber management enclosure (140; FIG. 2) coupled to the enclosure bracket (200), the fiber optic cable (120; FIG. 1) may then be installed into the fiber management enclosure (step 730; FIG. 7). FIG. 8 illustrates how a fiber optic cable (120) may be installed into the fiber management enclosure (140; FIG. 2). As shown in FIG. 8, the fiber optic cable (120) may be inserted through the compression fitting (240) coupled to the fiber tray housing (210). In order to insert the fiber optic cable (120) through the compression fitting (250 ), the cap of the compression fitting is partially unscrewed revealing an orifice sufficient for the fiber optic cable (120) to pass. Once inserted through the compression fitting (250), the fiber optic cable (120) is then fed into the fiber tray (220). If during installation or later servicing of the fiber optic cable (120) more room is desired to facilitate manipulation of the fiber optic cable (YES, step 740; FIG. 7), the fiber tray (220) may be removed from the fiber tray housing (step 750; FIG. 7). Removal of the fiber tray (220) from the fiber tray housing (210) is accomplished, according to one exemplary embodiment, by removing a number of fasteners (800) coupling the fiber tray (220) to the fiber tray housing (210). Once the fasteners (800) are removed, the fiber tray may be removed, providing additional space to manipulate the fiber optic cable (120) without removing the entire fiber management enclosure.

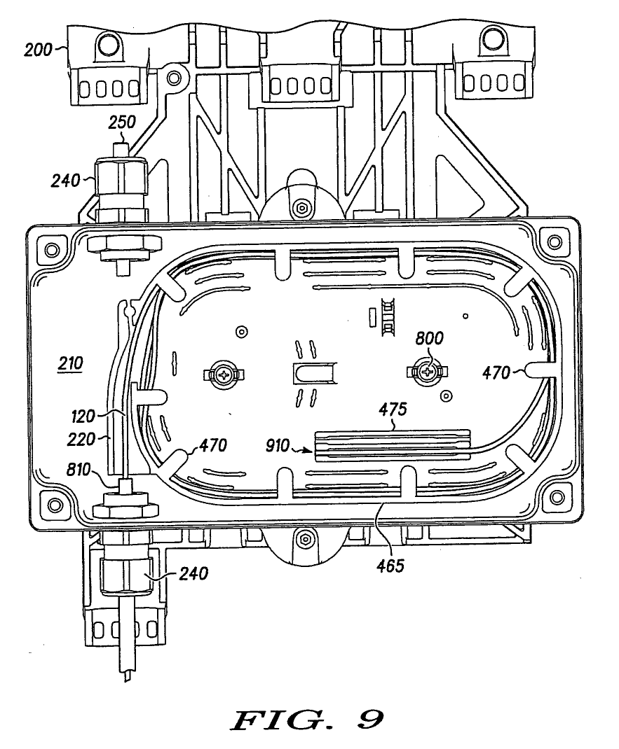

With the fiber optic cable (120) inserted in the fiber tray (220), multiple lengths of fiber optic cable may be routed in the raceways (465) of the fiber tray as shown in FIG. 9. Multiple lengths of fiber optic cable (120) may be routed in the raceways (465) of the fiber tray (220) and held in place by the fiber retaining extrusions (470). This ability to route multiple lengths of fiber optic cable (120) allows for the subsequent removal of the fiber tray (220) in order to install or otherwise manipulate the fiber optic cable. Moreover, the ability to install extra lengths of fiber optic cable (120) in the fiber tray (220) for future use allows for the installation of the fiber management enclosure (140; FIG. 2) either prior to or subsequent to the installation of an optical network terminal (150; FIG. 2).

Once the fiber optic cable (120) is appropriately routed in the raceways (465) of the fiber tray (220), the end of the fiber may be installed in the fusion splice housing (step 770; FIG. 7) including cutting the fiber optic cable even with the end (910) of the fusion splice housing (475) as shown in FIG. 9. The fusion splice housing (475) will sufficiently couple and protect the end of the fiber optic cable (120) until further use or manipulation is desired. Additionally, the enclosure cover (230; FIG. 2) may be coupled to the fiber fray housing (210) thereby environmentally sealing the fiber management enclosure (140 ; FIG. 2).

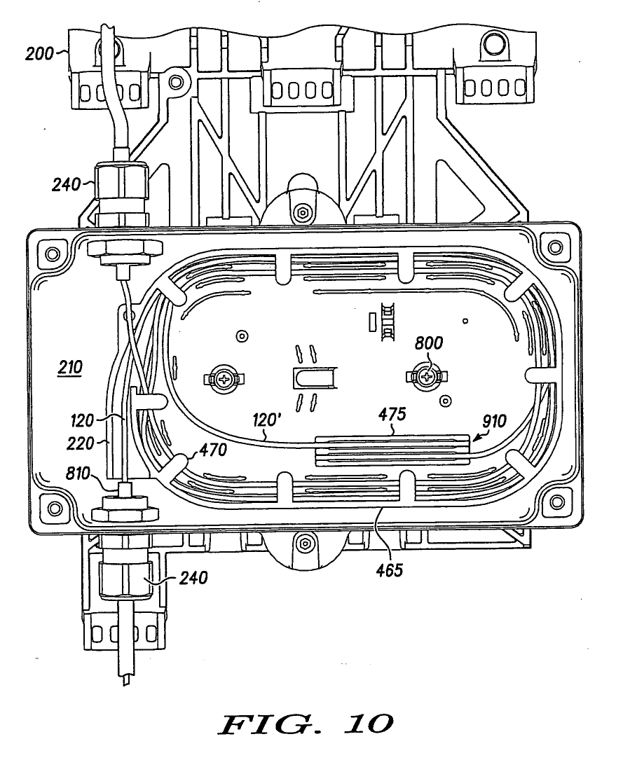

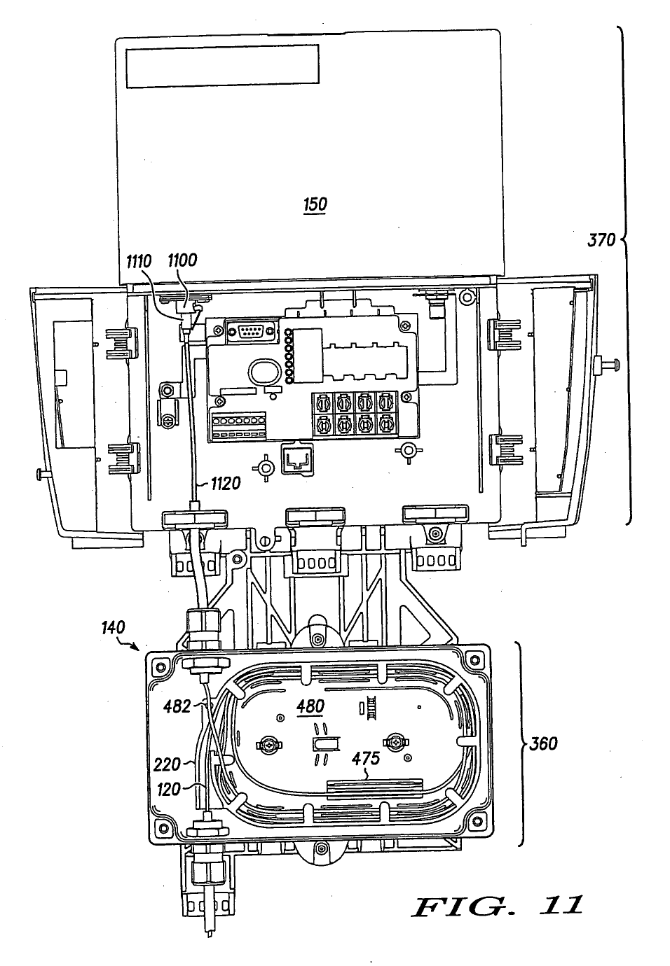

FIG. 10 illustrates how the present fiber management enclosure (140; FIG. 2) allows for the routing and storage of multiple fiber optic cables (120). As shown in FIG. 10, a first fiber optic cable (120) has been routed clockwise in the outer raceway (465) of the fiber tray (220) and secured in the fusion splice housing (475). Once one fiber optic cable (120 ) has been routed and secured in the fiber tray (220), a second fiber optic cable or other fiber optic cable connector (120′) may also be routed and secured in the fiber tray (220) as illustrated in FIG. 10. As shown, the second fiber optic cable or fiber optic cable connector (120′) may be received in the fiber tray (220) from either the optical network terminal (150; FIG. 2) or from the same source as the first fiber optic cable (120). Once received in the fiber tray (220), the second fiber optic cable or fiber optic cable connector (120′) is routed in the raceway (465) just inside the outer raceway and is routed counterclockwise. Once routed, the second fiber optic cable or fiber optic cable connector (120′) may be installed in the fusion splice housing (475) as shown in FIG. 10 until further use is desired.

FIG. 11 illustrates the coupling of a fiber optic cable (120) to an optical network terminal (150) according to one exemplary embodiment. As shown in FIG. 11, an ONT coupling device (1120) may be communicatively coupled to the fiber optic cable (120) within the fiber management enclosure (140). The ONT coupling device (1120) may be any device configured to couple a fiber optic cable (120) to an optical network terminal (150) including, but in no way limited to, a pigtail. The ONT coupling device (1120) may be passed through the upper compression fitting (250; FIG. 2) and channeled to the fiber tray (220) by the fiber channel or ferrule (482). Once channeled to the fiber tray (220), the ONT coupling device (1120) is routed counterclockwise in the raceway (465; FIG. 10) as described above with reference to FIG. 10. Additionally, the location where the ONT coupling device (1120) is coupled to the fiber optic cable (120) may be secured in the fusion splice housing (475) for protection. Once coupled to the fiber optic cable (120), the ONT coupling device may be coupled to an ONT connector (1100) by coupling an ONT coupling device connector (1110) to the ONT connector (1100) as shown in FIG. 11.

In conclusion, the present fiber optic cable management enclosure and method of use enables the routing of fiber optic cable to a consumer location. More specifically, the present fiber optic cable management enclosure facilitates the installation of an optical network terminal at a consumer home or small business by reducing the cost of fiber installation. Installation cost and complexity are reduced by simplifying the installation of service cable, channeling the internally routed fiber, protecting the fiber in an environmentally hardened enclosure, offering installation versatility in allowing the fiber to be installed prior to the installation of an optical network terminal, and allowing for the removal of the fiber tray and/or the fiber tray housing during maintenance or installation.

The preceding description has been presented only to illustrate and describe the present method and system. It is not intended to be exhaustive or to limit the present method and system to any precise form disclosed. Many modifications and variations are possible in light of the above teaching.

The foregoing embodiments were chosen and described in order to illustrate principles of the method and system as well as some practical applications. The preceding description enables others skilled in the art to utilize the method and system in various embodiments and with various modifications as are suited to the particular use contemplated. It is intended that the scope of the method and system be defined by the following claims.

We claim:

1. A fiber optic communication system comprising:
a fiber optic cable;
a consumer location;
an optical network terminal communicatively coupled to said consumer location; and
a fiber management enclosure configured to couple said optical network terminal to said fiber optic cable.

2. The fiber optic communication system of claim 1, wherein said fiber management enclosure comprises:
a body including an inlet and an outlet;
a removable fiber tray configured to be housed within said body, wherein said removable fiber tray is configured to accommodate said fiber optic cable.

3. The fiber optic communication system of claim 2, further comprising an enclosure bracket configured to couple said optical network terminal and said fiber management enclosure to said consumer location.

4. The fiber optic communication system of claim 2, further comprising:
a first compression filling associated with said inlet;
a second compression fitting associated with said outlet; and
a removable cover coupled to said body, wherein said cover is configured to environmentally seal said fiber tray within said body.

5. The fiber optic communication system of claim 4, wherein said first and said second compression fittings are configured to environmentally seal said fiber optic cable as said fiber optic cable enters or leaves said fiber optic cable routing apparatus.

6. The fiber optic communication system of claim 5, thither comprising a gasket coupled between said body and said cover.

7. A method for coupling a fiber optic cable to a user location comprising:
routing a fiber optic cable from a transmitter to said user location;
mounting a fiber management enclosure on said user location;
routing said fiber optic cable in said fiber management enclosure;
coupling an optical network terminal to said consumer location; and
coupling said fiber optic cable to said optical network terminal using a removable fiber tray that forms a part of said fiber management enclosure.

8. The method of claim 7, wherein said routing said fiber optic cable in said fiber management enclosure comprises:
routing a length of said fiber optic cable in a fiber channel of said removable fiber tray; and
coupling an end of said fiber optic cable in a fusion splice housing of said removable fiber tray.

9. The method of claim 8, wherein said coupling said fiber optic cable to said optical network terminal comprises:
fusion splicing said fiber optic cable to an optical network terminal coupler;
coupling said splice in said fusion splice housing; and
coupling said optical network terminal coupler to said optical network terminal.
